(19) United States
(12) Patent Application Publication
(10) Pub. No.: US 2018/0334321 A1
(43) Pub. Date: Nov. 22, 2018

(54) Transport Container

(71) Applicants: Johann Sen Strasser, Eugendorf (AT); Wolfgang Kalkhofer, Salzburg (AT)

(72) Inventors: Johann Strasser, Sen., Eugendorf (AT); Wolfgang Kalkhofer, Salzburg (AT); Johann Strasser, Jun., Eugendorf (AT); Wolfgang Strasser, Eugendorf (AT)

(21) Appl. No.: 15/777,655

(22) PCT Filed: Oct. 14, 2016
(86) PCT No.: PCT/AT2016/060075

§ 371 Date: May 19, 2018

(30) Foreign Application Priority Data
Nov. 19, 2015 (AT) A 50984/2015

(51) Int. Cl. B65D 88/12; E05F 15/53; E05F 1/10

(52) U.S. Cl. CPC B65D 88/127; B65D 88/126; B60J 5/0498; E05F 1/1041; E05F 15/53

(57) ABSTRACT

Transport container (1), in particular vehicle body or receptacle, with a frame structure (2) enclosing a transport space, with a wall unit (3) which is connected to the frame structure (2) and which has a side wall (4), and with an opening device (9) for transferring the wall unit (3) between a closure position bearing on the frame structure (2), in which closure position a lateral loading opening (10) of the frame structure (2) is closed by the side wall (4), and an open position freeing the lateral loading opening (10), wherein the opening device (9) has a lifting arm (11) connected in a hinged manner to the wall unit (3). The lifting arm (11) is connected to the frame structure (3) via two pivot arms (14), wherein hinges (15) are provided between the pivot arms (14) and the lifting arm, and hinges (16) are provided between the pivot arms (14) and the frame structure (2), wherein the hinges (15) between the pivot arms (14) and the lifting arm (11) and the hinges (16) between the pivot arms (14) and the frame structure (2) are arranged at a distance from each other in each case.

### TECHNICAL FIELD

The invention relates to a transport container, in particular vehicle body or container, having a frame structure enclosing a transport space, having a wall unit connected to the frame structure, the wall unit having a side wall, and having an opening mechanism for transferring the wall unit between a closed position resting against the frame structure, in which closed position a lateral loading opening of the frame structure is closed by the side wall, and an open position releasing the lateral loading opening, wherein the opening mechanism has a lift arm hingedly connected to the wall unit.

### BACKGROUND

A transport container is known from AT 509 550 B1. In this transport container, an L-shaped handlebar or lift arm is provided to guide the side wall of the transport container from the closed to the open position. The longer limb of the L-handlebar is pivotally mounted on the side wall, whereas the shorter limb of the L-handlebar is hinged to the frame of the transport container. To support the opening operation, a linear drive is provided which engages in the vertex region of the L-shaped handlebar. This kinematics has basically proven itself. Disadvantageously, however, the handlebar can only stretch over an angle of substantially 180° in the transfer to the open position.

EP 2 810 898 A1 discloses a generic transport container in which a pivoting device is provided for pivoting a side wall about a frame structure. The pivoting device has a lift arm element and a drive unit. A hinge element is provided between the frame structure and the lift arm element, the hinge element, on the one hand, being hingedly connected to the lift arm element and, on the other hand, hingedly connected to the frame structure. The drive unit has a linear drive, which transmits a torque to the lift arm element via a force transmission element. For this purpose, one end of the force transmission element is connected to the lift arm element and the other end of the force transmission element to the linear drive.

A vehicle body having a two-part side wall, which can be pivoted upwards into an open position, is known from US 2003/0127876 A1. A linear drive is provided for this purpose, which engages a curved pivot arm, which is connected at one end to the side wall. At the other end of the curved pivot arm, a connecting arm is provided, which is hinged on the vehicle body.

Accordingly, the invention has the object to eliminate or mitigate the disadvantages of the prior art. The invention therefore has the particular object of further developing a transport container of the type mentioned above, that the side wall can be pivoted by a larger pivot angle in the transfer to the open position with structurally simple means.

### SUMMARY

According to the invention, the lift arm is connected to the frame structure via two pivot arms, wherein hinges are provided between the pivot arms and the lift arm and hinges are provided between the pivot arms and the frame structure, wherein the hinges between the pivot arms and the lift arm and the hinges between the pivot arms and the frame structure respectively are arranged at a distance from each other.

Accordingly, the lift arm or handlebar is not directly on, but rather hinged via a pair of pivot arms on the frame structure of the transport container. In particular, a rigid element, preferably the length of which cannot be changed, is provided as a lift arm, with which element a torque is transmitted to the side wall during the opening operation. Preferably, the one ends of the pivot arms are connected via hinges to the frame structure and the other ends of the pivot arms via hinges to the lift arm. The hinges of the pivot arms on the side of the frame structure are preferably arranged fixed during the opening or closing operation. The hinges of the pivot arms on the side of the lift arm join in the pivoting movement of the lift arm. The lift arm is hingedly connected to the side wall, in particular to a side edge of the side wall. Through the mounting of the lift arm by means of two pivot arms, the lift arm is pivoted precisely along two opening curves in the direction of the open position. Preferably, exactly two pivot arms are provided between the lift arm and the frame structure. Advantageously, the lift arm can be pivoted between the closed and the open position by a pivoting angle of more than 180°, which is larger compared to the prior art, since the bearing of the lift arm via the pivot arms reliably prevents a collision of the lift arm with the frame structure at a pivoting of more than 180°. Accordingly, the pivot arms are set up to release a pivoting of the lift arm of more than 180°. This allows a particularly space-saving arrangement of the side wall in the open position. The opening mechanism according to the invention is also characterized by a particularly simple, part-saving and low-maintenance design.

The hinge axes of the hinges between the pivot arms and the frame structure, the hinge axes between the pivot arms and the lift arm and the hinge axes between the lift arm and the side wall preferably extend in the longitudinal direction of the transport container, which runs in a vehicle body in the direction of travel when driving straight ahead.

Preferably, each pivot arm is formed by two identical, mutually parallel pivot arm parts, which are hingedly connected to the opposite longitudinal sides of the lift arm.

For purposes of this disclosure, the location and directional references, such as “sideways,” “forward,” “rear,” “bottom,” “top,” “horizontal,” and “vertical,” refer to the intended use condition of the transport container.

According to a particularly preferred embodiment variant, the hinges between the pivot arms and the frame structure are spaced from one another substantially in the horizontal direction, perpendicular to their hinge axes, wherein the hinges between the pivot arms and the frame structure are preferably arranged substantially in the same horizontal plane. In this embodiment, the hinges of the pivot arms are arranged at a distance from one another on the side of the frame structure substantially in the transverse direction, that is, in the direction perpendicular to the longitudinal direction of the frame structure. Thus, the hinges of the pivot arms are pivoted on the side of the lift arm during the transfer of the wall unit from the closed to the open position along two different curved paths, in particular circular paths. In this case, the end region of the lift arm is lifted on the side of the frame structure by means of the pivot arms in sections from the roof region. It can thereby be achieved that, starting from the closed position, the lift arm can be pivoted into the open position of the wall unit by an angle of more than 180°.

For the articulation of the lift arm, it is advantageous when the hinges between the pivot arms and the frame structure are arranged on a roof region of the frame structure. Accordingly, the pivot arms are hinged at the upper region of the frame structure on this.

In order to ensure a secure guidance of the lift arm between the closed position and the open position, it is advantageous when the hinges between the pivot arms and the lift arm and the hinges between the pivot arms and the frame structure are arranged such that the pivot arms are arranged crosswise in sections in the transfer of the wall unit from the closed position to the open position. In this embodiment, the pivot arms cross at least during a section of the opening or closing operation of the wall unit.

The pivot arms may have approximately the same length. The length here refers in each case to the distance between the hinge on the frame structure and the hinge on the lift arm of each pivot arm. In addition, the hinges between the pivot arms and the lift arm, on the one hand, and the hinges between the pivot arms and the frame structure, on the other hand, may be arranged approximately at the same distance from one another.

To achieve a comparatively large opening angle of the side wall, it is favorable when the lift arm can be pivoted between the closed position and the open position of the wall unit by an angle of more than 225°.

For the transmission of torques on the lift arm and on the associated side wall, it is advantageous when the lift arm has two lift arm limbs arranged at an angle to one another, preferably at an acute angle. In this embodiment variant, the lift arm is configured substantially L-shaped. The lift arm limbs are preferably immovably connected to each other, so that the angle between the lift arm limbs is constant during the transfer from the closed to the open position. The configuration of the lift arm with two lift arm limbs allows a stable articulation of the lift arm via the one ends of the pivot arms, which are mounted articulated at their other ends to the frame structure.

To achieve advantageous leverage ratios in the pivoting of the side wall, it is advantageous when the one lift arm limb is connected with the pivot arms and the other lift arm limb is connected to the wall unit, in particular with a side edge of the side wall, wherein the lift arm limb connected to the wall unit preferably has a greater longitudinal extent than the lift arm limb connected to the pivot arms.

To guide the lift arm between the closed position and the open position, the one pivot arm is preferably hinged at the free end of the one lift arm limb, wherein the other pivot arm is preferably hinged in the region of the apex of the lift arm interconnecting the lift arm limbs. In this embodiment, the free end of the one lift arm limb is guided by means of the one pivot arm along a first curved path, in particular circular path. The other pivot arm engages substantially at the apex between the lift arm limbs so that the apex of the lift arm is guided along a second curved path, in particular a circular path.

The force transmission to the wall unit can be improved in which the one lift arm limb is arranged in the closed position of the side wall substantially parallel to the main extension plane of the side wall and the other lift arm limb substantially perpendicular to the main extension plane of the side wall.

For the automatic opening or closing of the transport container, it is advantageous when the opening mechanism has a drive, in particular a linear drive, preferably a cylinder piston drive, for transmitting torque to the lift arm.

With regard to the force transmission to the lift arm, it is advantageous when the drive is mounted at one end to one of the hinges between the pivot arms and the lift arm and at the other end to a hinge on the frame structure. The hinge on the frame structure is preferably fixed. Preferably, the drive engages in the region of the vertex of the lift arm.

According to a particularly preferred embodiment, a spring element is in each case connected to the frame structure and the wall unit such that the spring element is in a tensioned state when the wall unit is in the closed position and/or in the open position. The one end of the spring element can be connected via a hinge to the frame structure, the other end of the spring element via a further hinge to the wall unit, in particular to the side wall. Due to the arrangement of the spring element, the weight of the wall unit can be used to arrange the spring element in the closed position or in the open position in the tensioned state, in which spring energy is stored in the spring element. At the beginning of the opening operation or at the beginning of the closing operation, the spring element is discharged, so that the spring energy can be used to support the opening or closing operation. It is particularly preferred when the spring element is arranged in the tensioned state both in the closed position and in the open position. In this embodiment, the spring element is increasingly discharged, starting from the closed position, until the spring element is in an intermediate position of the wall unit in the discharged state. After that, the spring element is charged again, so that the spring element in the open position of the side wall in turn is in the tensioned state. The spring element provides spring energy during the transfer from the closed to the open position and vice versa in the phases of highest load. Preferably, the spring element is configured as a compression spring, which is loaded on pressure. For example, the compression spring may be a helical compression spring. In the tensioned state, the helical compression spring is compressed.

If the transport container is configured cuboid with two longitudinal sides, an upper side, a lower side and opposite end sides, the spring element can be arranged in a preferred embodiment on the one end side of the transport container and the above-described opening mechanism on the other end side of the transport container. In the case of a vehicle body, the spring element, as seen in the direction of travel, is preferably arranged on the front side of the frame structure.

For reasons of space and to reduce the loads occurring during the opening or closing operation, it is advantageous when the side wall has at least one upper side wall part and a lower side wall part, wherein the upper side wall part is connected to the lower side wall part via a swivel axle. The swivel axle between the upper and lower side wall part preferably runs in the longitudinal direction of the transport container.

According to a first preferred embodiment, the side wall is pivotally mounted about a fixed hinge axis on the roof region of the frame structure. In this embodiment, the above-explained guidance of the lift arm by means of the pivot arms holds the advantage that the side wall parts can be arranged in the open position above the roof region of the frame structure at an acute angle thereto. In a two-part embodiment of the side wall, the side wall parts are arranged in a folded-together state above the roof region of the frame structure in the open position.

For the purposes of this disclosure, “fixed” pivot or hinge axes are to be understood as those axes which are arranged immovable during the opening or closing operation apart from their bearing function.

According to an alternative preferred embodiment, the wall unit has a roof element hingedly connected to the side wall, which covers a roof opening of the frame structure in the closed position of the wall unit and releases the roof opening in the open position of the wall unit. In this embodiment, therefore, the wall unit not only has a side wall for selectively releasing a lateral loading opening, but also a roof element for selectively releasing a roof-side loading opening. The lateral loading opening and the roof-side loading opening extend over a large area between frame elements of the frame structure. The roof element is pivotally connected to the side wall via a hinge. The hinge axis between the roof element and the side wall preferably extends in the longitudinal direction of the frame structure. Due to the articulated connection between the roof element and the side wall, the roof element is brought together with the side wall from the closed to the open position. In the open position, the transport container can be loaded via the roof opening and the lateral loading opening. The roof element may be configured in one piece. Alternatively, the roof element may have a first and a second roof part.

It is particularly preferred when the upper and lower side wall part are arranged in the open position of the wall unit in a folded-together position on the longitudinal side of the frame structure facing away from the lateral loading opening. In the open position, the side wall parts are preferably arranged next to the frame structure, that is, not overlapping with the roof opening. Advantageously, thereby a large-area roof opening can be released, wherein the side wall does not hinder the loading of the transport container.

If, in the open position of the wall unit, the side wall is arranged at least partially, preferably by more than half the height of the side wall, below the roof region on the longitudinal side of the frame structure facing away from the lateral loading opening, the overall height of the transport container can be substantially reduced in the open position. This has the advantage, for example, that the transport container in the open position of the wall unit can be moved more easily and even at a limited height of the transport path. In addition, the loads on the opening mechanism can be reduced in the open position. Preferably, the side wall, based on its state in the open position, is arranged by more than half its height, defined as extension in the vertical direction, below the upper side of the frame structure. Depending on the embodiment, the side wall or the side wall parts may be arranged in the open position substantially perpendicular or at an angle to the vertical.

The invention will be explained below with reference to illustrated embodiments in the drawing, to which it is, however, not limited.

### BRIEF DESCRIPTION OF THE DRAWINGS

FIGS. 1, 2 are views of a transport container having a wall unit according to a first variant of the invention in the closed position.

FIG. 3 is a detailed view of an upper corner region of the transport container of FIGS. 1, 2 in the closed position.

FIGS. 4, 5 are views of the transport container of FIGS. 1 to 3 in a first intermediate position when transferring the wall unit from the closed position to the open position.

FIG. 6 is a view of the transport container of FIGS. 1 to 5 in a second intermediate position, which follows the first intermediate position during the opening operation.

FIG. 7 is a view of the transport container of FIGS. 1 to 5 in a third intermediate position, which follows the second intermediate position during the opening operation.

FIG. 8 is a view of the transport container of FIGS. 1 to 5 in a fourth intermediate position, which follows the third intermediate position during the opening operation.

FIGS. 9 to 11 are views of the transport container of FIGS. 1 to 8 in the open position.

FIG. 12 is a view of a transport container according to a second embodiment variant according to the invention in the closed position.

FIGS. 13, 14 are views of the transport container of FIG. 12 in successive intermediate positions.

FIGS. 15, 16 are views of the transport container of FIGS. 12 to 14 in the open position.

FIG. 17 is a view of a further embodiment according to the invention of the transport container in an intermediate position between the closed and the open position.

FIG. 18 is a view of the transport container of FIG. 17 in the open position.

### DETAILED DESCRIPTION

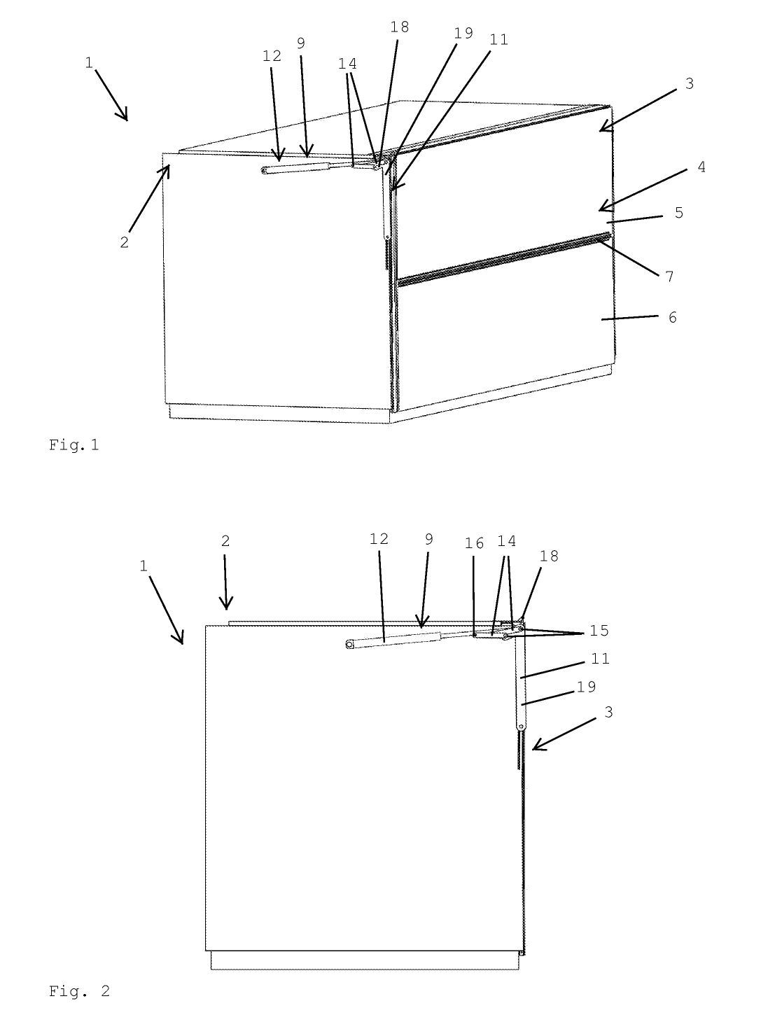

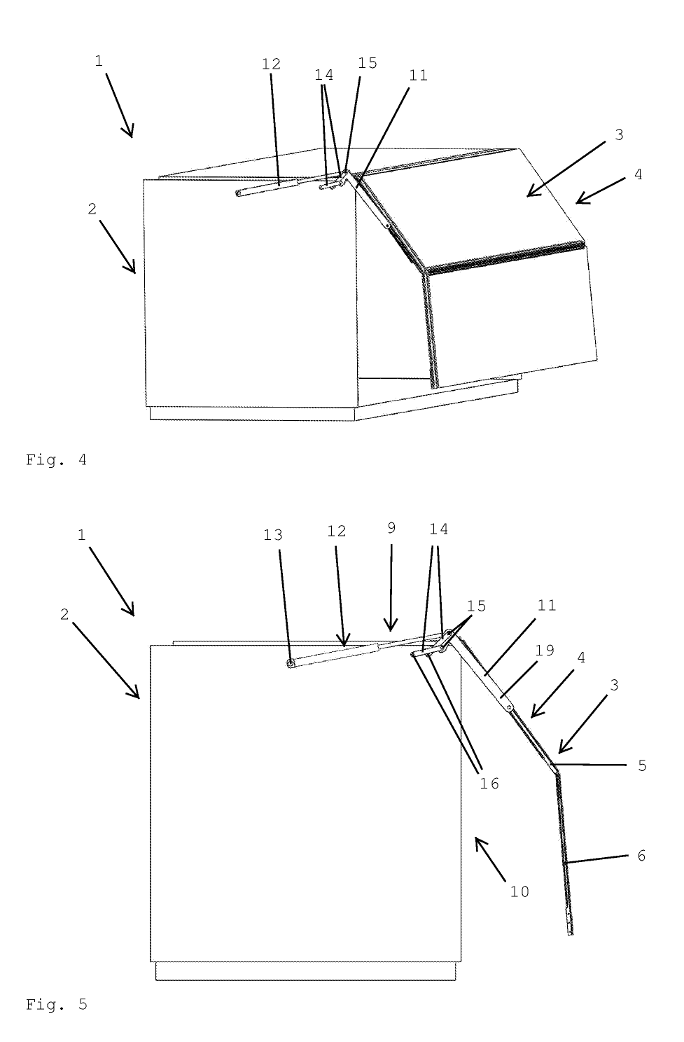

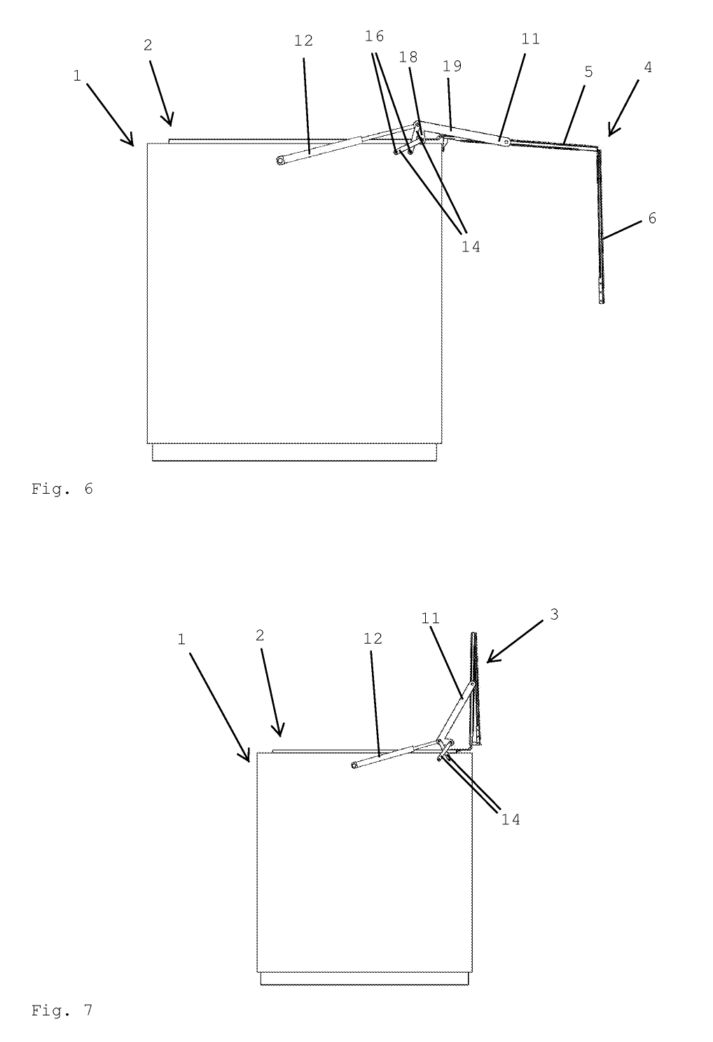

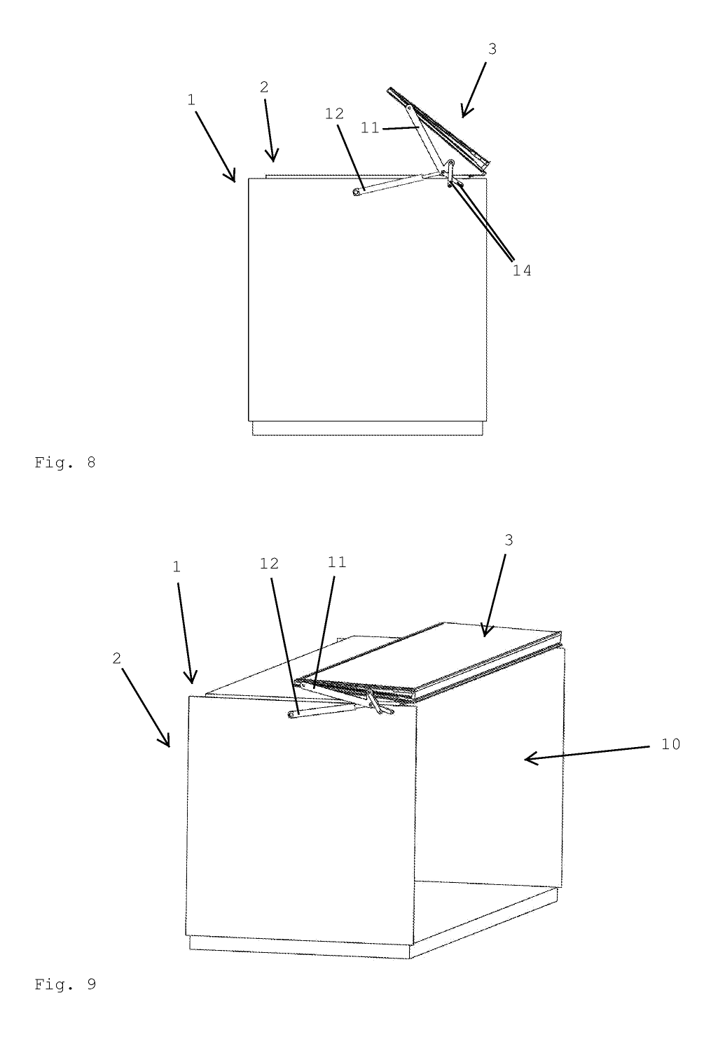

A substantially cuboid transport container 1, which is configured in particular as a vehicle body for a truck (not shown), is shown schematically in FIGS. 1 to 10. The transport container 1 has a frame structure 2, which is illustrated only schematically in the drawings, having horizontally and vertically arranged frame parts. The frame structure 2 of the transport container 1 includes a transport space for storing goods to be transported. The frame structure 2 is connected to a wall unit or a wall structure 3, which has a side wall 4. The side wall 4 consists of an upper side wall part 5 and a lower side wall part 6, wherein the upper side wall part 5 is connected to the lower side wall part 6 via a (relative to the operating position) substantially horizontal swivel axle 7. The lower end of the lower side wall part 6 may be connected to the frame structure via a steering device (not shown). The upper side wall part 5 and the lower side wall part 6 are each configured as full-surface panels. In addition, the upper side wall part 5 is pivotally mounted on the frame structure 2 via a fixed swivel axle 8. The fixed swivel axle 8 extends in a horizontal plane in the longitudinal direction of the transport container 1.

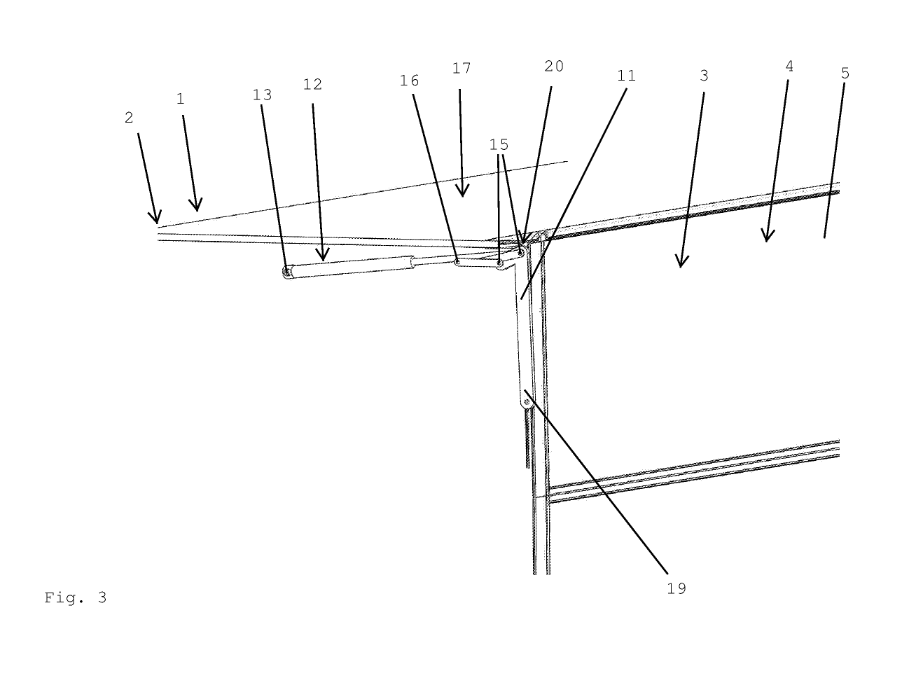

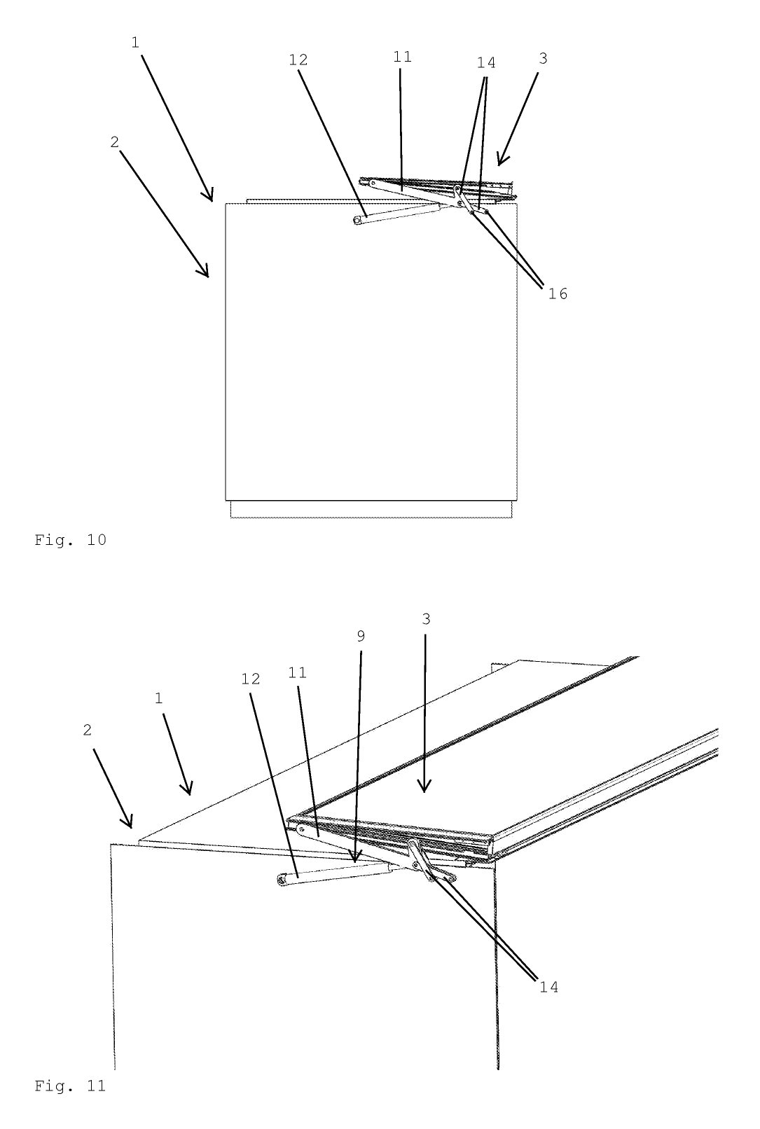

As can be further seen from FIGS. 1, 2, an opening mechanism 9 is also provided for the transfer of the wall unit 3 between a flat closing position resting against the frame structure 2 (see FIGS. 1, 2), in which a lateral loading opening 10 of the frame construction 2 is closed by the side wall 4, and an open position releasing the lateral loading opening 10 (see FIGS. 9, 10). The opening mechanism 9 has a lift arm 11, which is mounted articulated to a side edge of the side wall 4. In addition, the opening mechanism 9 has a drive 12 for transmitting torque to the wall structure 3. The drive 10 is configured as a linear drive in the form of a hydraulic or pneumatic cylinder piston drive. The drive 12 is mounted pivotally at one end on a fixed swivel axle 13 on the frame structure 2. At the other end, the drive 12 engages the lift arm 11.

As can be seen from FIGS. 1 to 10, the lift arm 11 is connected to the frame structure 2 by means of a pair of pivot arms 14, with which the lift arm 11 is guided during the opening or closing movement of the wall unit 3 such that the lift arm 11 and thus the side wall 4 can be pivoted by more than 180°. In the embodiment shown, the lift arm 11 is pivotable between the closed position and the open position of the wall unit 3 by an angle of more than 245°. For this purpose, the lift arm 11 is pivotally connected via hinges 15 to the one ends of the pivot arms 14, the other ends of which are hingedly connected via fixed hinges 16 to the frame structure 2.

As can be further seen from FIGS. 1 to 10, the hinges 15 between the pivot arms 14 and the lift arm 11, on the one hand, and the hinges 16 between the pivot arms 14 and the frame structure 2, on the other hand, are each arranged at a distance from one another. The hinges 16 between the pivot arms 14 and the frame structure 2 are substantially spaced apart from one another in the same horizontal plane, perpendicular to the longitudinal direction of the transport container 1. In the embodiment shown, the fixed hinges 16 of the pivot arms 14 are located on the side of the frame structure 2 on a roof region 17 of the frame structure 2.

As can further be seen from FIGS. 1 to 10, the pivot arms 14 together form a rod assembly, with which the lift arm 11 is guided along two circular paths during the opening or closing operation in order to prevent a collision with the roof region 17 of the frame structure 2. The hinges 16 of the pivot arms 14 on the frame structure 2 are spaced apart from one another such that the pivot arms 14 are arranged crosswise in an intermediate position between the closed and the open position of the wall unit 3.

As can further be seen from FIGS. 1 to 10, the lift arm 11 has two lift arm limbs 18, 19 arranged at an acute angle to one another, so that an L-shaped lift arm 11 is formed. The lift arm limb 18 is hinged to the pivot arms 14. The lift arm limb 19 is hingedly connected to the side edge of the side wall 4. In the embodiment shown, the lift arm limb 19 connected to the wall unit 3 is several times longer than the lift arm limb 18 connected to the pivot arms 14. In the closed position of the side wall 4, the lift arm limb 19 is arranged substantially parallel to the main extension plane of the side wall 4, that is, substantially vertical, and the lift arm limb 18 is arranged substantially perpendicular to the main extension plane of the side wall 4, that is, substantially horizontal.

As can further be seen from FIGS. 1 to 10, one of the pivot arms 14 is hinged at the free end of the lift arm limb 18. The further pivot arm 14 is hinged in the region of an apex 20 of the lift arm 11 interconnecting with the lift arm limb 18. In the embodiment shown, the drive 12 is pivotally mounted at one end about the hinge 15 at the apex 20 of the lift arm 11 and at the other end about the hinge 13 on the frame structure 2.

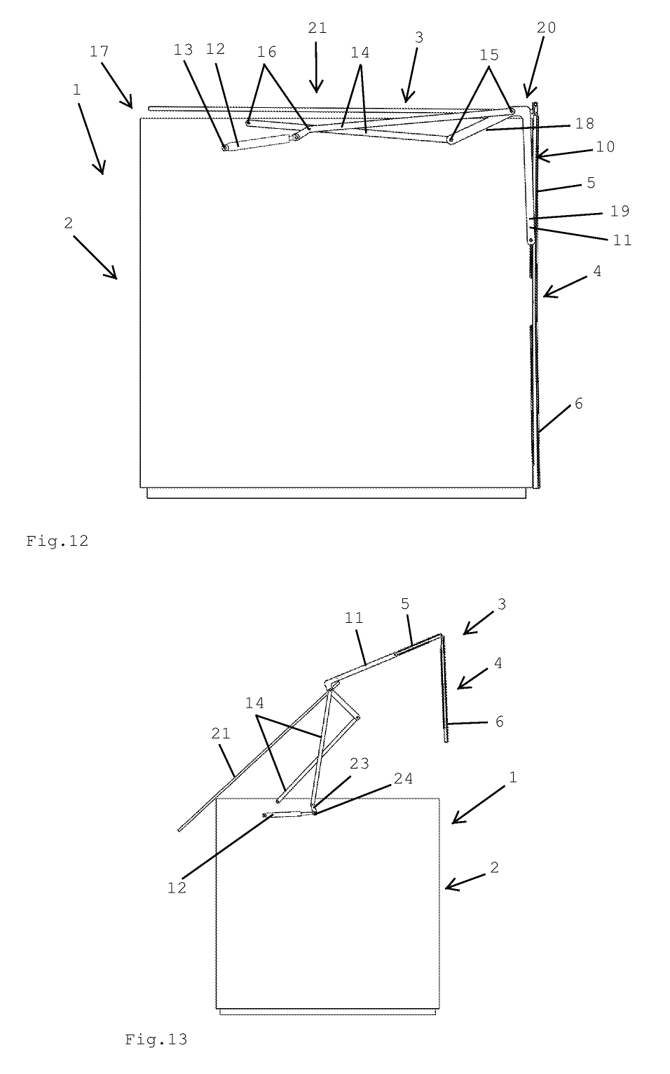

An alternative embodiment of the transport container 1 is shown in FIGS. 12 to 16, wherein only the differences from the embodiment of FIGS. 1 to 11 are discussed below.

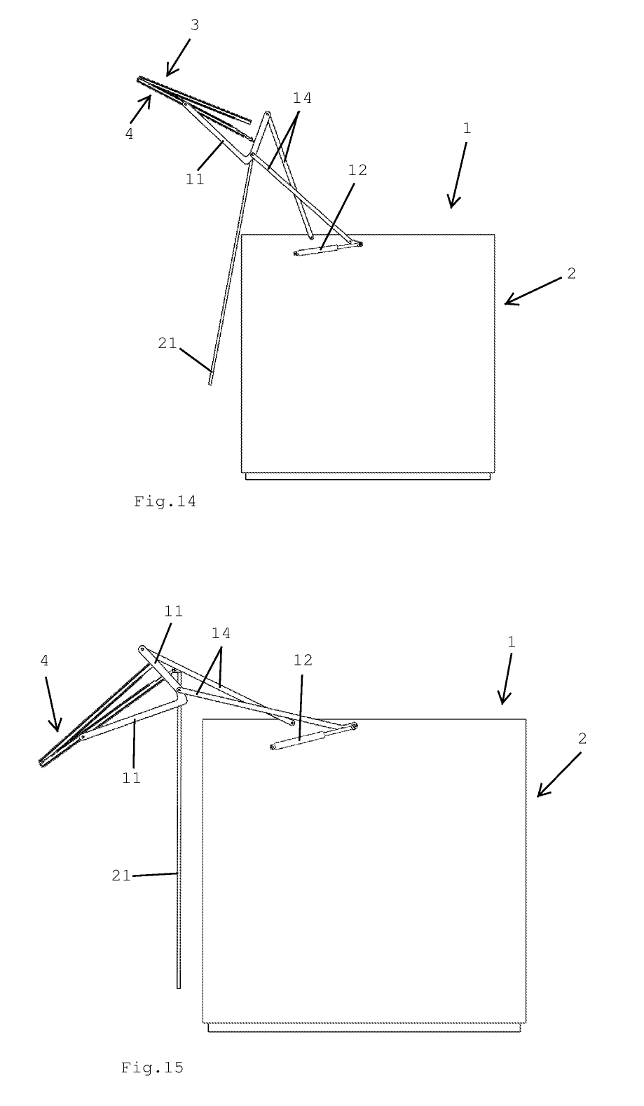

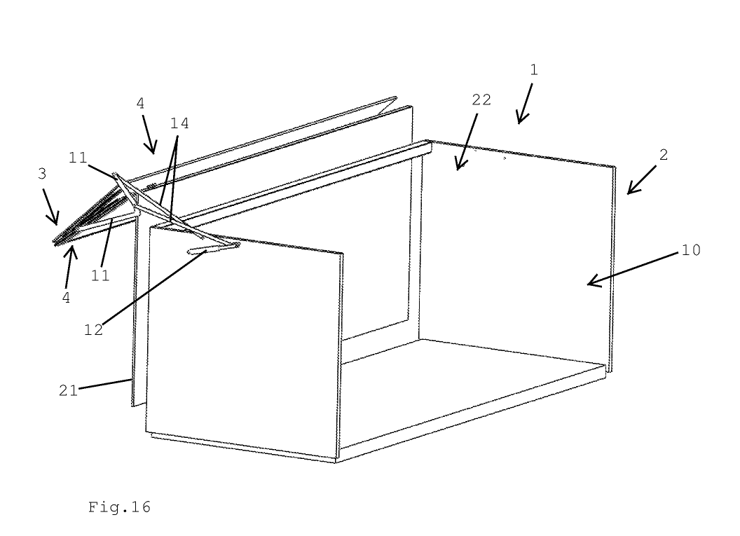

With the transport container 1 of FIGS. 12 to 16, the wall unit 3 has a roof element 21 hingedly connected to the side wall 4. In the embodiment shown, the roof element 21 is integrally formed. However, the roof element 21 may have first and second roof parts which are hingedly connected to one another (not shown). In the closed position of the wall unit 3 according to FIG. 12, the roof element 21 is arranged substantially horizontally, wherein an upper-side roof opening 22 of the frame structure 2, the roof opening extending in a horizontal plane, is covered. In the open position of the wall unit 3 (see FIGS. 15, 16), the roof opening 22 is exposed, so that the transport container 1 can be loaded, on the one hand, via the lateral loading opening 10 and, on the other hand, via the roof opening 22.

In the embodiment shown, one of the pivot arms 14 on the side of the hinge 16 facing away from the lift arm 11 has a linkage section 23 at the frame structure 2, the linkage section being connected via a hinge 24 to the drive 12. Thus, a torque is transmitted to the lift arm 11, which is hinged on the side wall 4, from the drive 12 via the pivot arm 14 with the linkage section 23. In this embodiment, therefore, an indirect force transmission takes place from the drive 12 via the pivot arm 14 with the linkage section 23 on the lift arm 11.

As can be seen from FIGS. 15, 16, in the open position of the wall unit, the upper 5 and lower side wall part 6 are arranged on the longitudinal side of the frame structure 2 facing away from the lateral loading opening 10 in a folded-together position, that is, lying flat on one another. The side wall 4 is located partially in the open position of the wall unit 3, in particular by more than half the height, below the roof region 17 on the longitudinal side of the frame structure 2 facing away from the lateral loading opening 10.

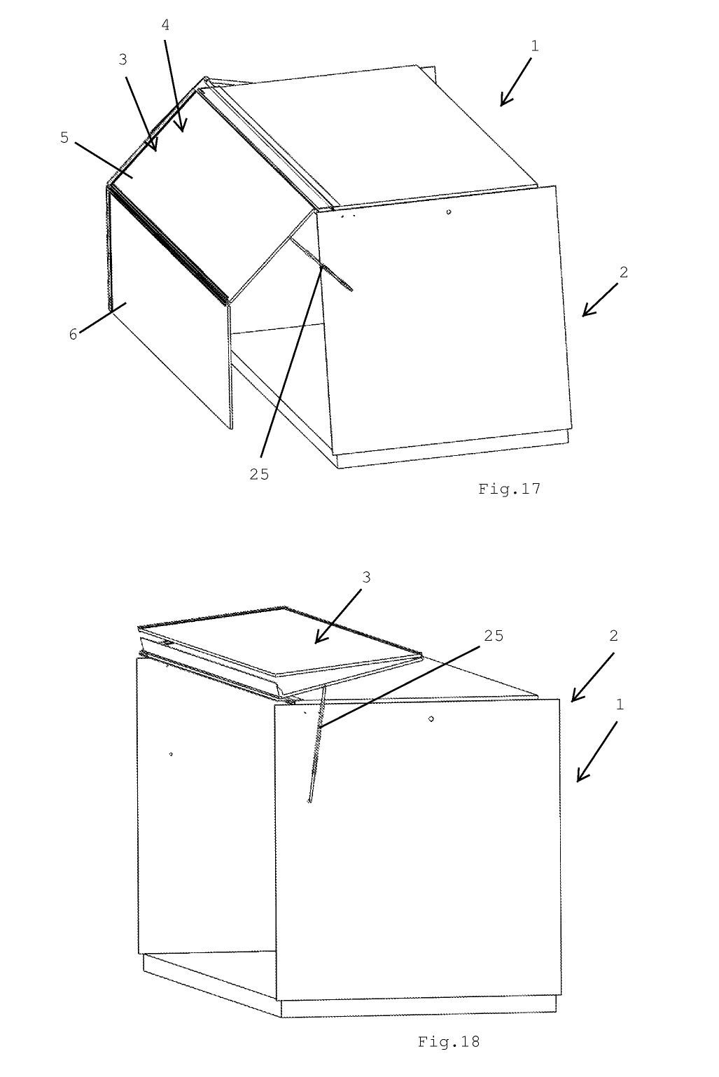

FIGS. 17, 18 show a further embodiment of the transport container 1, wherein only the differences from the embodiment of FIGS. 1 to 11 are explained below. In the embodiment of FIGS. 17, 18, a spring element 25 is arranged hinged between the frame structure 2 and the wall unit 3. The spring element 25 is tensioned upon reaching the closed position, so that the stored energy is available for the initiation of the opening operation.

Accordingly, the spring element 25 is tensioned upon reaching the open position (see FIG. 18), so that the stored energy is available for the initiation of the closing operation. A compression spring is provided as a spring element 25 in the embodiment shown, the spring element being formed by a coil spring. The spring element 25 is arranged on the front end side of the transport container 1. The opening mechanism is arranged on the rear end side of the transport container 1.

1.-17. (canceled)

18. A transport container (1), comprising:
a frame structure (2) enclosing a transport space;
a wall unit (3) connected to the frame structure (2), the wall unit having a side wall (4); and
an opening mechanism (9) for transferring the wall unit (3) between a closed position on the frame structure (2), in which a lateral loading opening (10) of the frame structure (2) is closed by the side wall (4), and an open position releasing the lateral loading opening (10),
wherein the opening mechanism (9) has a lift arm (11) hingedly connected to the wall unit (3),
wherein the lift arm (11) is connected to the frame structure (3) via two pivot arms (14),
wherein hinges (15) are provided between the pivot arms (14) and the lift arm (11) and hinges (16) are provided between the pivot arms (14) and the frame structure (2), and
wherein the hinges (15) between the pivot arms (14) and the lift arm (11) and the hinges (16) between the pivot arms (14) and the frame structure (2) are each arranged at a distance from one another.

19. The transport container (1) according to claim 18,
wherein the hinges (16) between the pivot arms (14) and the frame structure (2) are substantially spaced apart from one another in a horizontal direction perpendicular to their hinge axes.

20. The transport container (1) according to claim 19,
wherein the hinges (16) between the pivot arms (14) and the frame structure (2) are arranged substantially in the same horizontal plane.

21. The transport container (1) according to claim 18,
wherein the hinges (16) between the pivot arms and the frame structure are arranged on a roof region (17) of the frame structure (2).

22. The transport container (1) according to claim 18,
wherein the hinges (15) between the pivot arms (14) and the lift arm (11) and the hinges (16) between the pivot arms (14) and the frame structure (2) are arranged such that the pivot arms (14) are arranged crosswise in sections in the transfer of the wall unit (3) from the closed position to the open position.

23. The transport container (1) according to claim 18,
wherein the lift arm (11) is pivotable by an angle of more than 225° between the closed position and the open position of the wall unit (3).

24. The transport container (1) according to claim 18,
wherein the lift arm (11) has two lift arm limbs (18, 19) arranged at an angle to one another.

25. The transport container (1) according to claim 24,
wherein the two lift arm limbs (18, 19) are arranged at an acute angle to one another.

26. The transport container (1) according to claim 24,
wherein a first of the two lift arm limbs (18) is connected to the pivot arms (14) and a second of the two lift arm limbs (19) is connected to the wall unit (3), and
wherein the second lift arm limb (19) connected to the wall unit (3) has a greater longitudinal extension than the first lift arm limb (18) connected to the pivot arms (14).

27. The transport container (1) according to claim 24,
wherein one of the two pivot arms (14) is hinged at a free end of one of the two lift arm limbs (18), and
wherein the other pivot arm (14) is hinged in a region of an apex (2) of the lift arm (11) which interconnects the two lift arm limbs (18, 19).

28. The transport container (1) according to claim 24,
wherein one of the two lift arm limbs (18), in the closed position of the side wall, is arranged substantially parallel to a main extension plane of the side wall (4) and the other lift arm limb (19) is arranged substantially perpendicular to the main extension plane of the side wall (4).

29. The transport container (1) according to claim 18,
wherein the opening mechanism (9) has a drive (12) for transmitting torque to the lift arm (11).

30. The transport container (1) according to claim 29,
wherein the drive (12) is a linear cylinder piston drive.

31. The transport container (1) according to claim 29,
wherein the drive (12) is pivotably mounted at one end to one of the hinges (15) between the pivot arms (14) and the lift arm (11) and at the other end to a hinge (16) on the frame structure (2).

32. The transport container (1) according to claim 18,
wherein a spring element (25) in each case is connected to the frame structure (2) and the wall unit (3) such that the spring element (25) is in a tensioned state in the closed position and/or in the open position of the wall unit (3).

33. The transport container (1) according to claim 18,
wherein the side wall (4) has at least one upper side wall part (5) and a lower side wall part (6), and
wherein the upper side wall part (5) is connected to the lower side wall part (6) via a swivel axle (7).

34. The transport container (1) according to claim 33,
wherein the side wall is pivotally mounted about a fixed hinge axis on a roof region (17) of the frame structure (2).

35. The transport container (1) according to claim 33,
wherein the wall unit (3) has a roof element (21) hingedly connected to the side wall (4), which roof element covers a roof opening (22) of the frame structure (2) in the closed position and the roof opening (22) releases the wall unit (3) in the open position.

36. The transport container (1) according to claim 35,
wherein the upper (5) and the lower side wall part (6) are arranged in a folded-together position on a longitudinal side of the frame structure (2) facing away from the lateral loading opening (10) in the open position of the wall unit (3).

37. The transport container (1) according to claim 18,
wherein the side wall (4) is arranged by more than half a height of the side wall (4) below a roof region (17) on a longitudinal side of the frame structure (2) facing away from the lateral loading opening (10) in the open position of the wall unit (3).
